(19) United States
(12) Patent Application Publication
(10) Pub. No.: US 2004/0237123 A1
(43) Pub. Date: Nov. 25, 2004

(54) Apparatus and method for operating closed caption of digital TV

(76) Inventor: Jae Jin Park, Gyeonggi-Do (KR)

Correspondence Address: BIRCH STEWART KOLASCH & BIRCH, PO BOX 747, FALLS CHURCH, VA, 22040-0747, US

(21) Appl. No.: 10/849,943

(22) Filed: May 21, 2004

(30) Foreign Application Priority Data
May 23, 2003 (KR) 2003/33061

(51) Int. Cl. H04N 7/173; H04N 7/16; H04N 7/00

(52) U.S. Cl. 725/136; 725/131; 348/468

(57) ABSTRACT

An apparatus and method for operating a closed caption are disclosed. The apparatus for operating a closed caption includes an MPEG video processor for receiving a digital broadcast signal, detecting video information and PSIP (Program and System Information Protocol) information and processing it; a DTVCC decoder for extracting DTVCC information and analog CC information from the video information detected in the MPEG video processor and decoding the DTVCC information; and an analog CC decoder for receiving the analog CC information from the DTVCC decoder and decoding it. In providing a DTVCC service according to ATSC standards, the best closed service is provided under a given condition when there is an error in a broadcast station.

### BACKGROUND OF THE INVENTION

1. Field of the Invention

The present invention relates to a closed caption broadcast and, more particularly, to an apparatus and method for operating a closed caption capable of providing the best closed caption broadcast in a situation that a closed caption service provided from a broadcast station has an error, in a closed caption broadcasting of an ATSC (Advanced Television System Committee)-based digital TV system.

2. Description of the Background Art

A closed caption broadcast was initially developed for the ear-handicapped and has been applied to every ANV (AudioNideo) media since an analog television was widely spread. When the analog television was spread, an FCC (Federal Communications Commission) of the United States stipulated that every television having a screen of larger than a certain size should have a function of decoding a closed caption to be displayed on a screen. In the closed caption broadcast of the analog TV, closed caption information is transmitted by encoding 2-byte information in two fields (Field 1 and Field 2) of the 21^{st} line of a VBI (Vertical Blanking Interval) band.

For instance, in case of the North America, types of analog closed cap broadcast service based on EIA-608 (Electronic Industries Association-608) includes CC1, CC2, CC3, CC4, Text 1, Text 2, Text 3 and Text 4. CC1 and CC2 provide a primary language. Specifically, CC1 provides the primary language and CC2 provides a closed caption service of the same language as CC1 but in an easy language for people, such as children or elderly people, who cannot quickly read letters. CC3 and CC4 provide a secondary language. Specifically, CC3 provides the secondary language and CC4 is used for a special purpose like the relation between CC1 and CC2 for the same closed caption. Namely, in case of an analog television closed caption broadcast in the North America, the primary language is English and the secondary language is Spanish, so CC1 and CC2 can be English while CC3 and CC4 can be Spanish.

In the above-described analog television closed caption broadcast, the closed caption setting should be determined by a user personally. However, as for the provided closed caption service, information on which closed caption service is provided for an actual broadcast program is not provided, so, disadvantageously, the user must check it personally while changing each closed caption setting. In addition, the actually provided closed caption broadcast generally provides CC1 and sometimes CC3 as well. And, CC2, CC4, Text1, Text2, Text3 and even Text 4 are rarely provided.

The recent digital television system environment stipulates that every digital television receiver should mount a DTVCC (Digital Television Closed Caption) function to provide a reinforced closed caption service.

FIG. 1 is an exemplary view of DTVCC caption data in a general DTV bit stream.

As shown in FIG. 1, the closed caption broadcast of the digital television system employs the DTVCC standards (EIA 708) defined in ATSC (Advanced Television Systems Committee). Namely, in the DTVCC standards, closed caption data is transmitted by using a user data region of a picture header according to an MPEG (Motion Picture coding Experts Group)-II video standards and ATSC standards (A53). In this case, the closed caption data can be transmittable by up to a maximum 128 bytes, and a total transmission amount cannot exceed 9600 bps. Accordingly, it shows total ten times of increase of bandwidth compared to the EIA-608-based analog CC (Closed Caption) standards where the total transmission amount cannot exceed 960 bps.

Thus, the actual DTVCC (Native DTVCC) of the EIA-708-based digital broadcast can provide total 63 types of closed caption services in consideration of the extended bandwidth. However, it is very unreasonable for the user to go through such a trial and error over the 63 types of closed caption services like in the analog CC.

Thus, in order to overcome that, a digital broadcast signal provided by a broadcast station includes PSIP (Program and System Information Protocol) information in addition to program information. The program information refers to TV programs provided by broadcasting companies to be broadcast to subscribers, including user information such as video information, audio information and caption data. The PSIP information refers to a set of table devised to describe information of a specific channel.

In detail, in case of providing the DTVCC according to the ATSC standards, the broadcasting station should necessarily include information called a caption_service_descriptor in an EIT (Event Information Table) or a PMT (Program Map Table) of the PSIP. Namely, the caption service descriptor is used for the digital television receiver to recognize what kind of DTVCC is included in a corresponding program, such as, for example:

Caption Service 1: English

Caption Service 2: Spanish

Caption Service 3: English (with easy_reader flag)

Caption Service 4: Spanish (with easy_reader flag)

Caption Service 5: French

Caption Service 6: French (with easy_reader flag).

Thus, when the DTV receiver informs the user on a corresponding program, the user can select a desired closed caption or a closed caption service suitable for a language the user has previously set can be automatically selected.

FIG. 2 is an exemplary view showing a general digital television system performing a closed caption broadcast by using a digital TV set-top box receiver.

As shown in FIG. 2, in the digital television broadcast, the closed caption broadcast does not simply provide only the actual DTVCC (Native DTVCC) by the EIA-708). Namely, the user data region including the DTVCC includes also an analog CC by units of 2-byte based on EIA-608. This is because the digital television broadcast provides an S-VHS or a composite output so that the existing analog TV receiver can receive a broadcast signal, and in this case, the analog CC data transmitted by being carried in the user data region is reversely encoded and outputted to a VBI line 21 of the S-VHS or composite output so that the closed caption broadcast can be performed through an analog CC decoder mounted in the analog TV receiver.

A basic purport of the function is that when the DTV signal is stored through the analog TV signal recorder such as VCR, if the closed caption information is not carried reversely in the VBI line 21, the closed caption cannot exist when the stored signal is reproduced. In other words, the purport of the function is to avoid such a situation that when a content, which has been stored in the VCR when displayed on a screen by the DTVCC decoding, is reproduced, the user can view the closed caption but it is no more closed caption but an open caption.

As stated above, the digital television signal used in the North America is transmitted with the actual DTVCC (Native DTVCC) data based on the EIA-708 standards and the analog CC data based on the EIA-608 standards mixed in a picture header thereof, information on what kind of DTVCC service exists in the PSIP is included in the caption service descriptor.

However, an actual broadcast situation in the North America shows that the broadcast is not operated strictly according to the defined standards in most cases. As a matter of course, in case of major broadcasts, the above matters are well recognized and the DTVCC is properly included for broadcasting, but most broadcast stations cannot understand the complex situations related to the DTVCC properly but simply recognize that closed caption information need only be included in the digital TV signal just like the closed caption is put in the existing analog TV signal. This causes various errors.

One example of typical errors is that the native DTVCC and the analog CC data are included in a broadcast signal but the caption service descriptor is not transmitted. In a different example, only the analog CC data is transmitted without the native DTVCC and it is determined that all the data for closed caption broadcast have been transmitted, but actually, even the caption service descriptor is not included in the PSIP.

Especially, such an error as the second example occurs frequently, and when a broadcast station transmits a broadcast signal in such an error-generated state, a DTV receiver strictly following the ATSC standards cannot process the DTVCC.

### SUMMARY OF THE INVENTION

Therefore, an object of the present invention is to provide an apparatus and method for operating a closed caption of a digital television capable of providing the best closed caption broadcast in a situation that a closed caption service provided from a broadcast station has an error by performing a decoding as necessary as well as an encoding on a VBI of an S-VHS output or a composite output with respect to analog CC data in a DTV signal.

To achieve these and other advantages and in accordance with the purpose of the present invention, as embodied and broadly described herein, there is provided an apparatus for operating a closed caption of a digital television, including: an MPEG processor for detecting video information and PSIP (Program and System Information Protocol) information contained in a digital broadcast signal and processing it; and a decoding unit for decoding a DTVCC or an analog CC with reference to the PSIP detected in the MPEG processor.

To achieve the above objects, there is also provided a method for operating a closed caption of a digital television including: a step in which when a caption_service_descriptor is contained in PSIP information and a native DTVCC is provided in video information, a DTVCC decoding is performed to output a DTV CC, or if the caption_service_descriptor is not contained in the PSIP information or the native DTVCC is not provided in the video information, an analog CC decoding is performed to output an analog CC; and a step in which the DTVCC or the analog CC is displayed in overlap with a video signal on a screen.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an exemplary view showing DTVCC caption data in a general DTV bit stream;

FIG. 2 is an exemplary view showing a general digital television system performing a closed caption broadcast by using a digital TV set-top box receiver;

FIG. 3 is a block diagram of an apparatus for operating a closed caption of a digital television in accordance with the present invention;

FIG. 4 is a flow chart of a method for operating a closed caption of the digital television in accordance with the present invention;

FIG. 5A is a table showing a method for automatically determining a user setting when a DTVCC is received by using analog CC user set information; and

FIG. 5B is a table showing a method for automatically determining a user setting when an analog CC is received by using a DTVCC user set content.

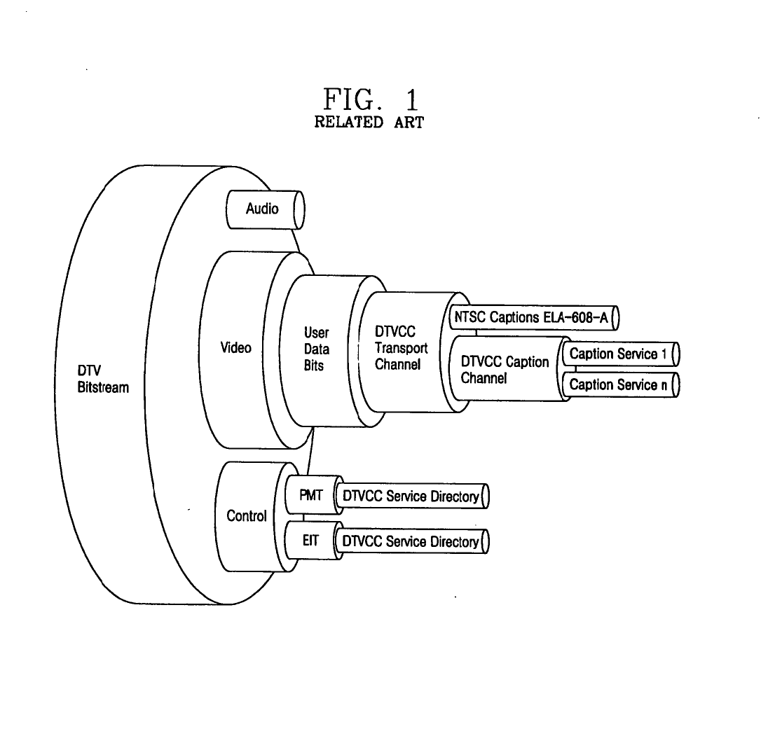

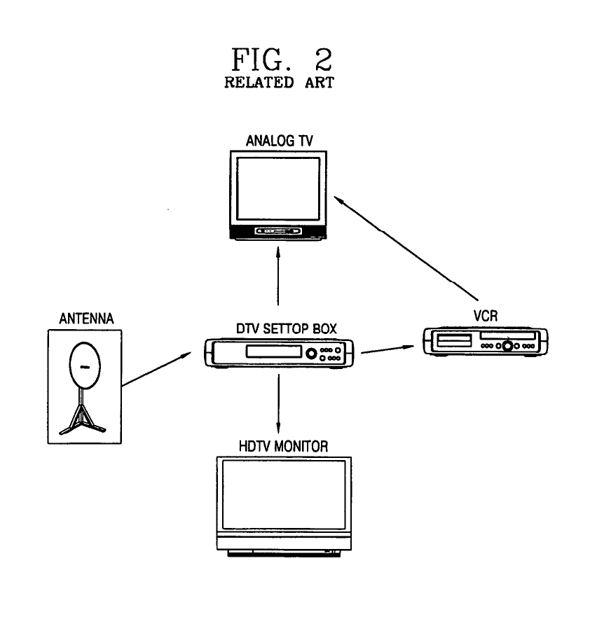

### DETAILED DESCRIPTION OF THE PREFERRED EMBODIMENTS

Reference will now be made in detail to the preferred embodiments of the present invention, examples of which are illustrated in the accompanying drawings.

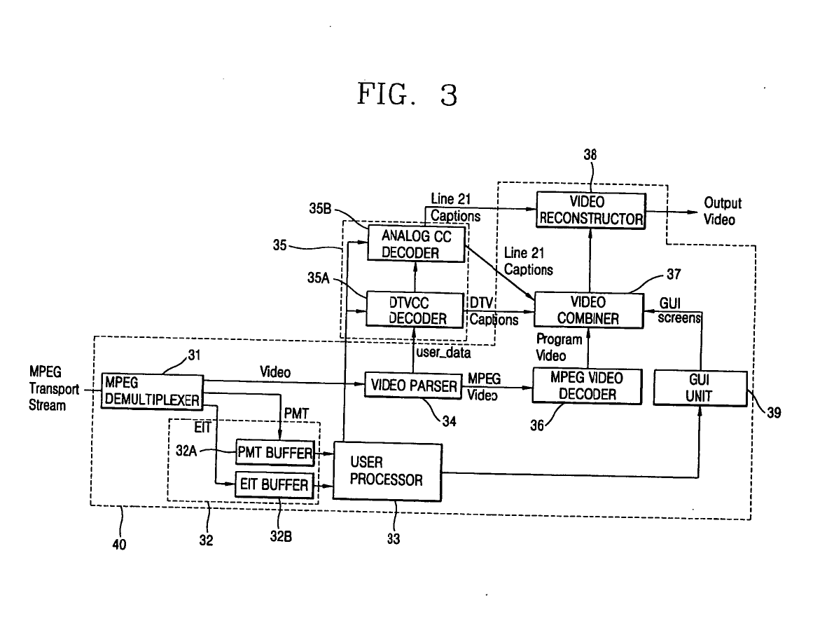

FIG. 3 is a block diagram of an apparatus for operating a closed caption of a digital television in accordance with the present invention.

As shown in FIG. 3, an apparatus for operating a DTVCC closed caption in accordance with the present invention includes: an MPEG processor 40 for receiving a digital broadcast signal (MPEG transport stream), detecting video information and PSIP (Program and System Information Protocol) information, and processing them; and a decoding unit 35 for decoding a DTVCC or an analog CC with reference to the PSIP detected in the MPEG processor.

The decoding unit 35 includes a first decoder 35A for extracting DTVCC information and analog CC information from the video information detected in the MPEG processor 40 and decoding the DTVCC information; and a second decoder 35B for receiving the analog CC information and decoding it. For example, the decoding unit 35 can include a DTVCC decoder as the first decoder 35A and an analog CC decoder as the second decoder 35B.

The MPEG processor 40 includes an MPEG demultiplexer 31 for receiving the digital broadcast signal (MPEG transport stream) and extracting audio, video and other supplementary information (e.g., closed caption information or PSIP information); a PSIP processor 32 having a PMT (Program Map Table) buffer 32A and an EIT (Event Information Table) 32B respectively for storing a PMT or an EIT of the PSIP information outputted from the MPEG demultiplexer 31, and extracting a caption_service_descriptor stored in the buffers to describe information on a specific channel; a user processor 33 for controlling an operation for selecting the DTVCC decoder 35B if the caption_service_descriptor is included in the PSIP information and an actual DTVCC (native DTVCC) is provided, and selecting the analog CC decoder 35B if the caption_service_descriptor is not included in the PSIP information or the native DTVCC is not provided; a video parser 34 for parsing video data outputted from the MPEG demultiplexer and outputting MPEG video data and user data; an MPEG video data 36 for extracting a picture from the MPEG video data parsed from the video parser 34 and decoding it; a GUI unit 39 for outputting a GUI signal under the control of the user processor 33; a video combiner 37 for combining the decoded DTV CC or analog CC, the video Is outputted from the MPEG video decoder 36 and the GUI signal outputted from the GUI unit 39, and outputting a closed caption-contained video signal; and a video reconstructor 38 for combining an output signal of the analog CC decoder 35B and the video signal of the video combiner 37 and outputting a final video signal.

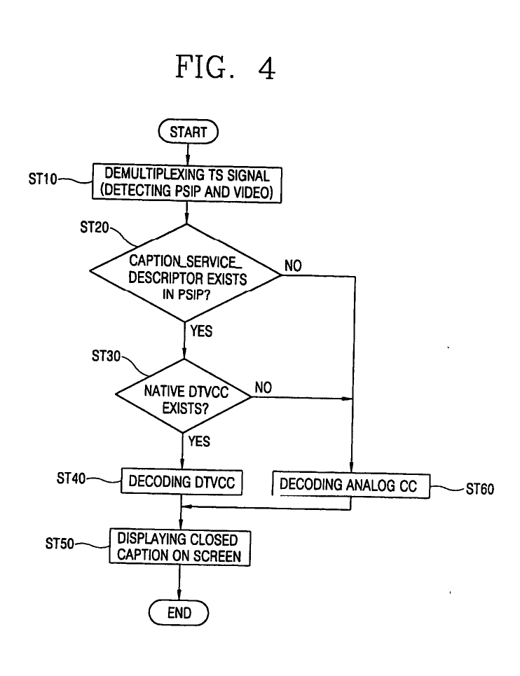

FIG. 4 is a flow chart of a method for operating a closed caption of the digital television in accordance with the present invention.

As shown in FIG. 4, a method for operating a closed caption of a digital television in accordance with the present invention includes: a demultiplexing step of separating video and PSIP information from a transport stream of a digital broadcast signal (step ST10); a step of determining whether a caption_service_descriptor is contained in the PSIP information (step ST20); a step of determining whether a native DTVCC is contained in a picture header of the video information (step ST30); a step of performing a DTVCC decoding and outputting a DTV caption if the caption_service_descriptor are the native DTVCC are contained (step ST40); a step of performing an analog CC decoding and outputting an analog caption if the caption_service_descriptor or the native DTVCC is not contained (step ST60); and a step of overlapping the DTVCC or the analog CC on the video signal and displaying it on a screen (step ST50).

The processing operation of the apparatus and method for operating a closed caption of a digital television will now be described in detail.

First, the digital broadcast signal (MPEG transport stream) is decoded by the MPEG demultiplexer (31) and demultiplexed to video, audio and other information. The PMT and the EIT of the PSIP are separately stored in the PMT buffer 32A and the EIT buffer 32B.

The user processor 33 searches the caption_service_descriptor stored in the PMT buffer 32A and the EIT buffer 32B to find a closed caption service identical to language information set by a user. A service ID of the found closed caption service is transferred to the DTVCC decoder 35A.

The video data separately detected through the MPEG demultiplexer 31 is parsed in the video parser 34, from which MPEG video data is detected. In this process, the user data included in the picture header is transferred to the DTVCC decoder 35A, and then, the DTVCC decoder 35A searches user's desired closed caption service information from the inputted user data and decodes it.

The DTVCC decoder 35A extracts the analog caption data from the user data, and if the S-VHS or the composite output is detected therefrom, the DTVCC decoder 35A encodes it and transfers it to the analog CC decoder 35B so that it can be carried and transmitted on a certain vertical blanking interval (VBI) line 21.

Finally, the DTVCC decoded in the DTVCC decoder 35A is combined with the video outputted from the MPEG-2 video data 36 and the GUI screen information outputted from the GUI unit 39, and then transmitted to the video reconstructor 38, thereby generating a final video output.

Meanwhile, in the apparatus for operating the DTVCC closed caption in accordance with the present invention, if the DTVCC is not contained in the channel of a corresponding digital TV or even if the DTVCC is contained but the caption_service_descriptor is not included so existence of DTVCC cannot be not known, at least analog CC service is provided.

The analog CC decoding process will now be described.

When the user processor 33 detects the caption_service_descriptor, the DTVCC is decoded and displayed on the screen.

However, if the user processor does not detect the caption_service_descriptor or if the caption_service_descriptor is detected but the DTVCC service information is not included, the analog CC decoder 35B is used. In other words, the user processor 33 includes a non-volatile random access memory storing caption information that the user has set, and can select the analog CC decoder 35B or the DTVCC decoder 35A through the first table for automatically setting a caption language when the DTVCC is received by using the caption information set as the analog CC by the user and a second table for automatically setting caption information when the analog CC is received by using a caption language set as the DTVCC by the user.

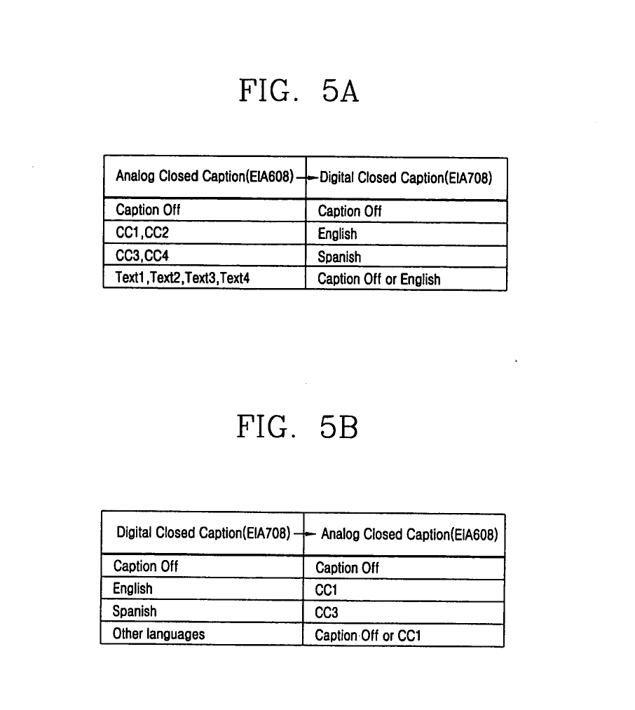

FIG. 5A is a table showing a method for automatically determining a user setting when a DTVCC is received by using analog CC user set information, and FIG. 5B is a table showing a method for automatically determining a user setting when an analog CC is received by using a DTVCC user set content.

With reference to FIGS. 5A and 5B, it is assumed that there exists the caption_service_descriptor and the user selects the Spanish language. At this time, the user processor 33 stores the fact that the user has selected the Spanish language for a caption in a memory.

Thereafter, if the caption_service_descriptor is not detected due to a channel switching, the user processor 33 selects CC3 by using the table of FIG. 5B and informs the analog CC decoder 35B accordingly.

The video combiner 37 combines the analog CC which has been decoded through the analog CC decoder 35B, the video outputted from the MPEG video decoder 36 and the GUI signal outputted from the GUI unit, and outputs a video signal. Then, the analog CC decoder 35B encodes the S-VHS or the composite output, contains it in a certain VBI line and transmits it to the video reconstructor 38.

The video reconstructor 38 finally outputs a video signal having the closed caption of the video combiner 37 and the output signal of the analog CC decoder 35B.

For instance, when the user, who has selected CC3 in receiving the analog television channel, receives a digital television channel, if the DTVCC is contained in the corresponding digital television channel, the Spanish language is automatically set by the table as shown in FIG. 5A. If, however, the DTVCC is not contained, CC3 selected in the analog television channel is applied as it is when the digital television channel is received.

Conversely, when the user, who has selected the Spanish language when the digital television channel is received, changes it to a digital television channel that does not include the DTVCC or to an analog channel, CC3 is selected according to the table as shown in FIG. 5B.

The reason of requiring the above processing operation is that a person who wants to view the caption would mostly be an ear handicapped, and especially, a person who selects the caption other than CC1 can be considered to be familiar to a language (e.g., the Spanish language) other than the English language, the primary language, and if there is no caption completely identical to a set language, it would be helpful to show the person at least the English caption.

As so far described, the apparatus and method for operating a closed caption in accordance with the present invention have the following advantages.

That is, for example, first, if there occurs an error in a broadcast station in the digital television of the North America standards, the best closed caption service is provided under the given conditions.

Second, a user can automatically set a caption language when a DTVCC is received by using caption information set when the analog CC was received, or the user can automatically caption information when an analog CC is received by using a caption language set when DTVCC was received.

Third, when the digital television receiver receives an analog TV and S-VHS external input or a composite external input as well as the digital television broadcast signal, it associates and processes the first table and the second table describing the caption language information set by a user. Accordingly, a user interface that can be easily understood at the side of the user with respect to the complicate DTVCC standards is used and thus users' convenience can be maximized.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

What is claimed is:

1. An apparatus for operating a closed caption of a digital television, comprising:
an MPEG processor for detecting video information and PSIP (Program and System Information Protocol) information contained in a digital broadcast signal and processing it; and
a decoding unit for decoding a DTVCC or an analog CC with reference to the PSIP detected in the MPEG processor.

2. The apparatus of claim 1, wherein if a caption_service_descriptor is included in the PSIP information and an actual DTVCC (native DTVCC) is provided, the decoding unit decodes the DTVCC, whereas if the caption_service_descriptor is not included in the PSIP information or the native DTVCC is not provided, the decoding unit decodes the analog CC.

3. The apparatus of claim 1, wherein the decoding unit comprises:
a first decoder for extracting DTVCC information and analog CC information from the video information detected in the MPEG processor and decoding the DTVCC information; and
a second decoder for receiving the analog CC information from the first decoder and decoding it.

4. The apparatus of claim 3, wherein the first decoder is a DTVCC decoder and the second decoder is an analog CC decoder.

5. The apparatus of claim 1, wherein the MPEG processor includes a user processor for selecting closed caption information in the PSIP provided from the digital broadcast signal and closed caption information set by a user.

6. The apparatus of claim 5, wherein the user processor comprises:
a first table for automatically setting a caption language when the DTVCC is received by using the caption information set as the analog CC by the user; and
a second table for automatically setting caption information when the analog CC is received by using a caption language set as the DTVCC by the user.

7. The apparatus of claim 5, wherein the MPEG processor comprises:
an MPEG demultiplexer for extracting audio, video and other supplementary information from an MPEG transport stream of the digital broadcast signal;
a PSIP processor for describing information of a specific channel from the supplementary information;
a video parser for extracting MPEG video data and user data from the MPEG demultiplexer;
an MPEG video decoder for extracting a picture from the MPEG video data extracted (parsed) by the video parser and decoding it;
a GUI unit for outputting a GUI signal under the control of the user processor; and
a video combiner for combining the decoded DTV CC or analog CC, the video outputted from the MPEG video decoder and the GUI signal outputted from the GUI unit, and outputting a video signal.

8. The apparatus of claim 7, wherein the supplementary information is closed caption information or PSIP information.

9. The apparatus of claim 7, wherein the PSIP processor includes a PMT (Program Map Table) buffer and an EIT (Event Information Table) buffer for storing a PMT or an EIT in the PSIP information, respectively.

10. The apparatus of claim 9, wherein the PSIP processor extracts a caption_service_descriptor from the PMT buffer and the EIT buffer.

11. The apparatus of claim 5, wherein the MPEG processor further comprises:
a video reconstructor for combining an output signal of the decoding unit and an output signal of the video combiner and generating a final video output.

12. The apparatus of claim 11, wherein the decoding unit includes an analog CC decoder, and the analog CC decoder encodes an S-VHS or a composite output detected from the DTVCC decoder, contains it in a certain VBI line and transmits it to the video reconstructor.

13. The apparatus of claim 5, wherein the user processor includes a non-volatile memory storing caption information set by a user.

14. An apparatus for operating a closed caption of a digital television, comprising:
a decoding unit for decoding a DTVCC or an analog CC; and
a user processor for controlling the decoding unit to decode native DTVCC service information desired by a user if PSIP information includes a caption_service_descriptor and a native DTVCC is provided, or decode analog CC service information desired by the user if the PSIP information does not include the caption_service_descriptor or the native DTVCC is not provided.

15. The apparatus of claim 14, wherein the decoding unit comprises:
a first decoder for detecting the native DTVCC caption service information and decoding it; and
a second decoder for decoding analog CC data if the caption_service_descriptor is not decoded in the user processor or if the caption_service_descriptor is detected but the DTVCC service information is not included therein.

16. The apparatus of claim 15, wherein the first decoder is a DTVCC decoder and the second decoder is an analog CC decoder.

17. The apparatus of claim 16, wherein the analog CC data is separated through the DTVCC decoder.

18. The apparatus of claim 17, further comprises:
an MPEG demultiplexer for extracting audio, video and other supplementary information from an MPEG transport stream of the digital broadcast signal;
a PSIP processor for describing information of a specific channel from the supplementary information;
a video parser for parsing the video data extracted from the MPEG demultiplexer and detecting MPEG video data and user data;
an MPEG video decoder for extracting a picture from the MPEG video data extracted (parsed) by the video parser and decoding it;
a GUI unit for outputting a GUI signal under the control of the user processor;
a video combiner for combining the decoded DTV CC or analog CC, the video outputted from the MPEG video decoder and the GUI signal outputted from the GUI unit, and outputting a video signal; and
a video reconstructor for combining an output signal of the analog CC decoder and an output signal of the video combiner and generating a final video output.

19. The apparatus of claim 14, wherein the user processor selects decoding of the closed caption by using a first table for automatically setting user setting when a DTVCC is received by using a user setting when analog CC was received; and a second table for automatically determining user setting when an analog CC is received by using user setting when the DTVCC was received.

20. The apparatus of claim 14, wherein the user processor selects decoding of the closed caption by having a first table describing types of caption services set by the user when an analog television signal, an S-VHS external input signal or a composite external input signal is received and a second table describing caption language information set by the user when the digital television signal is received.

21. The apparatus of claim 20, wherein a caption language is automatically set when the DTVCC is received by using caption information set by the user when the analog CC was received on the basis of the first table, and caption information is automatically set when the analog CC is received by using a caption language set by the user when the DTVCC was received on the basis of the second table.

22. A method for operating a closed caption of a digital television comprising:
a step in which when a caption_service_descriptor is contained in PSIP information and a native DTVCC is provided in video information, a DTVCC decoding is performed to output a DTV CC, or if the caption_service_descriptor is not contained in the PSIP information or the native DTVCC is not provided in the video information, an analog CC decoding is performed to output an analog CC; and
a step in which the DTVCC or the analog CC is displayed in overlap with a video signal on a screen.

23. The method of claim 22, further comprising:
a demultiplexing step of separating video and PSIP information from a transport stream of a digital broadcast signal;
a step of determining whether a caption_service_descriptor is contained in the PSIP information; and
a step of determining whether a native DTVCC is contained in a picture header of the video information.

24. The method of claim 22, wherein a caption language is automatically set when the DTVCC is received by using caption information set by the user when the analog CC was received, and caption information is automatically set when the analog CC is received by using a caption language set by the user when the DTVCC was received.
